(19) United States
(12) Patent Application Publication
(10) Pub. No.: US 2017/0255020 A1
(43) Pub. Date: Sep. 7, 2017

(54) HEAD MOUNTED DISPLAY WITH DIRECTIONAL PANEL ILLUMINATION UNIT

(71) Applicant: Sharp Kabushiki Kaisha, Osaka (JP)

(72) Inventors: Ka Ho Tam, Oxford (GB); David James Montgomery, Bampton (GB); Andrew Kay, Oxford (GB); Peter John Roberts, Oxford (GB); Marco Zanola, Oxford (GB)

(21) Appl. No.: 15/061,024

(22) Filed: Mar. 4, 2016

(51) Int. Cl. G02B 27/01; G06F 3/01

(52) U.S. Cl. CPC G02B 27/0179; G02B 27/0172; G02B 27/0176; G06F 3/013; G02B 2027/0187; G02B 2027/0174; G02B 2027/013; G02B 2027/0152; G02B 2027/0112

(57) ABSTRACT

A head mounted display device includes a switchable light source that is switched to emit light for generating at least one viewing zone, and a panel illumination unit illuminated by the light source. The panel illumination unit converges the light onto an image panel that selectively transmits light at different pixels to generate image content. An eye monitor measures information pertaining to an eye configuration of a user, and the image content is visible to the user when the eye is aligned with respect to the viewing zone. The panel illumination unit converges the light such that light emitted by the image panel converges into the viewing zone positioned based on the eye configuration information measured by the eye monitor, with limited divergence such that when the display device is worn by the user, the image panel is located at a distance from the user's eye closer than a distance where the eye can focus the pixels.

### TECHNICAL FIELD

The invention has application within the field of wearable displays. It is used for achieving a light weight design in head mounted displays.

### BACKGROUND ART

Head-Mounted-Displays (HMD) is a type of device with increasing popularity within the consumer electronics industry. HMDs, along with similar devices such as helmet-mounted displays, smart glasses, and virtual reality headsets, allow users to wear a display device such that the hardware remains fixed to their heads regardless of the person's movement.

When combined with environmental sensors such as cameras, accelerometers, gyroscopes, compasses, and light meters, HMDs can provide users with experiences in virtual reality and augmented reality. Virtual reality allows a user to be completely submerged into a virtual world where everything the user sees comes from the display device. On the other hand, devices that provide augmented reality allow users to optically see the environment. Images generated by the display device are added to the scene and may blend in with the environment.

One of the primary elements of HMDs is a display module mounted onto the head. However, since the unaided human eye cannot accommodate for images closer than a certain distance from the eye, eye piece lenses are required to re-image the display module such that the display appears to be at a comfortable viewing distance from the user. Such optical configuration requires lots of space between the eye piece and the display module. Furthermore, complex lenses are needed if the HMD needs to display images with high quality and wide field of view. These lenses often make the device very bulky to wear.

A number of methods had been invented to eliminate the need of heavy lenses in HMDs. Light field displays use a high resolution image panel with a microlens array to integrate subsets of images onto different parts of the retina. This method leads to images with low effective resolution. Retinal scanning displays are capable of producing images with resolution equivalent to the native resolution of the laser scanner. However, the stringent requirement to align the scanning mirror through the eye's pupil means that it is very difficult to fabricate an HMD that fits different anthropometric variations.

Holographic HMDs typically suffer from several problems. Firstly, image quality is typically poor as spatial light modulators (SLMs) are only available for either phase or amplitude modulation but not both. Computational holograms often suffer from what is known as the zero order which consists of light appearing in unwanted regions on the retina. Secondly, speckle is usually visible in holographic displays which use laser sources. Thirdly, an ideal holographic image requires using an SLM with very high resolution or small pixel size comparable to optical wavelengths. This also means holographic images would typically require very high computational load.

WO9409472A1 (Furness et al., published Apr. 28, 1994), WO2015132775A1 (Greenberg, published Sep. 11, 2015), U.S. Pat. No. 8,540,373B2 (Sakakibara et al., issued Mar. 31, 2011), JP2013148609A (Pioneer, published Jan. 8, 2013, and JP5237267B2 (Yamamoto, issued Jul. 17, 2013) describe representative retinal scanning displays where a collimated beam and scanning mirrors are used to directly rasterize an image onto the retina. These devices include a gaze tracker which determines the gaze direction of the eye. Apart from the scanning mirrors that rasterizes the image, additional mechanical mirrors are used to move the single eye point of the optical system depending on eye position obtained from a gaze tracker. High accuracy/low latency gaze trackers are crucial if these systems are to work as designed. However, currently no gaze trackers can achieve desirable reliability. Also, scanning beam systems are often expensive.

U.S. Pat. No. 6,751,026B2 (Tomono, issued Jun. 15, 2004) describes a retinal direct projection display where a “light-speed controlling element” is used to make divergent light from the planar backlight into light parallel to an optical axis. However, having parallel light emerging from the image forming element may lead to poor energy efficiency as well as poor brightness uniformity in the HMD system, as the pupil size of the eye is typically much smaller than the image panel. In addition, the system requires a Fresnel lens after the image forming element to focus the image onto the retina. Large space will be required either between the Fresnel lens and the eye and/or between the image forming element and the Fresnel lens. This will make the device bulky.

JP4319028B2 (Dietrich, issued Dec. 24, 2004) describes a retinal projection system where an image is directly projected onto the retina. However, a conventional projection lens is used in the system. These lenses will make the device very large and heavy.

### SUMMARY OF INVENTION

This invention concerns a design of a wearable display which enables the device to have reduced weight relative to known configurations without compromising other technical performances. The design is particularly suitable for head mounted displays or smart glasses with applications in virtual reality (VR) and augmented reality (AR).

The design involves the use of a special panel illumination unit which produces light converging towards the eye with high directionality. This converging light passes through an image panel, which attenuates light selectively at different pixels. The image panel is physically located close to the eye at a distance much closer than a normal unaided eye can accommodate. However, the high directionality of the panel illumination unit allows light emerging from each pixel to have a small divergence angle. Because of this, the eye can focus on the pixels, allowing a clear image to be visible without the need of large spaces or large optical elements between the image panel and the eye.

Unlike the prior art, in this invention optical elements with a single (or a small number of) optical axis is not necessary for the eye to accommodate for the image. Furthermore, the system does not need to employ “light field/integral imaging” type algorithms which may reduce the display's effective resolution. This means the user could potentially see the image at its full resolution equivalent to the panel's resolution.

The image panel may be a transparent display panel such as a liquid crystal display or a Microelectromechanical system shutter array. The image panel may also be a reflective display such as a liquid crystal on silicon (LCoS) or a Digital micro-mirror device (DMD), in which case the optics may have to be folded up with additional optics such as beam splitters.

The panel illumination unit may include a curved surface, such as a free form mirror, an approximately ellipsoid surface, or a mirror array with elements small enough that the surface can be considered curved at large scales. Alternatively, the panel illumination unit may include known diffractive and refractive features capable of performing similar functions.

At the scale of the HMD, light emerging from the image panel remains convergent towards the eye. However, at individual pixel scale, light emerging from each pixel is slightly divergent due to diffraction from the effective aperture of each pixel. Light emerging from each pixel has a divergence that is sufficiently small such that, at the pupil of the eye, the beam diameter is comparable to or smaller than the pupil diameter. The divergence can be changed to some extent by varying the shape parameters of the panel illumination unit.

However, the divergence of light emerging from pixels can also be improved by adding a lens array element after the image panel and decreasing the fill factor of the pixels. This lens array element is a thin element which could be a simple refractive lens array. Alternatively, the lens array may be an array of phase and/or amplitude diffractive lenses. It is also possible to design each lenslet such that they overlap spatially, with each lenslet only diffracting light emerging from specific pixels. This will allow light emerging from each pixel to be expanded and have a smaller divergence

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1: First embodiment of this invention, showing the principal optical elements.

FIG. 2: First embodiment of this invention,

FIG. 2(a): Showing how multiple viewing zones can be created by switching on different light sources.

FIG. 2(b): Showing the operating principle of the device.

FIG. 3: First embodiment of this invention, showing several possible shapes of the back light illumination unit.

FIG. 3(a): An ellipsoid/free form mirror.

FIG. 3(b): A reflective mirror converted into a Fresnel structure. The curved surface may have curvatures close to an ellipsoid.

FIG. 3(c): The optical element has a partially reflective surface embossed into a substrate with matching refractive index on both sides.

FIG. 3(d): The optical element could be shaped to create convergent rays such that instead of converging all rays towards a single point, rays corresponding to wide viewing angles converging further back towards the rotation pivot of the eye compared to paraxial rays.

FIG. 3(e): Rays corresponding to wide viewing angles in the direction of gaze remain unobstructed by the iris of the eye.

FIG. 4: Second embodiment, where the transparent display unit is curved.

FIG. 5: Third embodiment

FIG. 5(a): Where the image panel includes a layer of lens array for improved collimation of light emerging from each pixels.

FIG. 5(b): Showing the image panel with pixel size as much smaller than the pixel pitch to achieve high spatial coherence.

FIG. 6: Fourth embodiment, where a microlens array is placed before the image panel to improve efficiency of light coupling into each pixel.

FIG. 7: Fifth embodiment,

Figure (a): Where the micro-lenses are an array of spatially overlapping phase and/or amplitude diffractive lenses.

Figure (b): Showing one possibility of overlapping diffractive lenses by using adjacent lenses with different color filters such that each diffractive lens is only visible to its matching pixel.

Figure (c): Showing one possibility of maximizing the distance between two diffractive lenses visible to the same wavelengths.

Figure (d): Showing one possibility of effectively increasing the number of color filters by using different permutations of color filter pairs.

Figure (e): Showing diffractive lenses fabricated onto a non-planar substrate such that each diffractive lens will be visible to a different spectrum.

FIG. 8: Sixth embodiment, where a light steering element is used to steer light towards the eye's pupil.

FIG. 9: Seventh embodiment, where a reflective image panel is used in place of the transparent image panel.

### DESCRIPTION OF REFERENCE NUMERALS

1: Light source
   (a-b) Independently switchable light source
2: Diverging Beam
3: Image panel
4: Eye
5: Pupil of the eye
6: Retina of the eye
7: Image pixel
8: Converging light/Backlight incident onto image panel
10: Panel illumination unit
11: Eye monitor
12: Contour of ellipsoid Fresnel lens according to the first embodiment
13: Partially reflective coating according to the first embodiment
14: Transparent substrate according to the first embodiment
15: Converging Point of light converging from small angle (paraxial) from the optical axis
16: Converging Point of light corresponding to wide viewing angle
17: Rays obstructed by the eye/iris of the eye
18 (a-b): Different Viewing Zones
20: Image panel according to the second embodiment
31: Image panel according to the third embodiment
32: Lens array in the image panel according to the third embodiment
33: Optical axis of a lenslet according to the third embodiment
40: Panel illumination unit according to the fourth embodiment
41: Second lens array in the panel illumination unit according to the fourth embodiment
42: Light beam focused through image pixel according to the fourth embodiment
50: Overlapping diffractive/holographic lens array according to the fifth embodiment
51: Overlapping diffractive/holographic lens made of a plurality of different color filters (R, G, B)(a-h) according to the fifth embodiment
52: One diffractive/holographic micro-lens according to the fifth embodiment
53: Transmission of pixel color filter according to the fifth embodiment
54: Transmission of diffractive/holographic lens color filter according to the fifth embodiment
55: Substrate with non-uniform surface according to the fifth embodiment
56: Diffractive lenses fabricated onto substrate according to the fifth embodiment
57: Tunable light source according to the fifth embodiment
60: Spatial light modulator according to the sixth embodiment
70: Panel illumination unit according to the seventh embodiment
71: Reflective image panel according to the seventh embodiment
200: Convergence angle of light emerging from panel illumination unit.
201: Distance between the image panel and the eye.
202: Closest distance between micro-lens transmitting the same wave length
203: Wavelength of a wavelength-tunable light source

### DETAILED DESCRIPTION OF INVENTION

An aspect of this invention is a head mount display or similar display devices that are fixed to the head. In exemplary embodiments, the display device includes a light source, a panel illumination unit, an image panel, and an eye monitor. The panel illumination unit is characterized by its geometry, being structured such that light emerging from the panel illumination unit would converge to a small area towards the eye. The image panel displays a pattern that attenuates the illumination light at individual pixels. The image panel is physically located close to the eye at a distance much closer than an unaided eye could accommodate.

### 1^{st} Embodiment

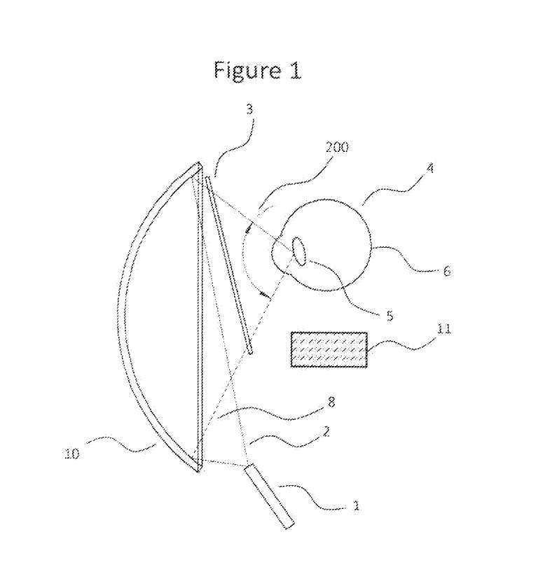

The first embodiment of this invention is shown in FIGS. 1-3. In exemplary embodiments, a head mounted display device includes a switchable light source that is switched to emit light for generating at least one viewing zone, and a panel illumination unit that is illuminated by the light source. The device further includes an image panel, wherein the panel illumination unit converges the light onto the image panel and the image panel selectively transmits light at different pixels to generate image content. An eye monitor measures information pertaining to an eye configuration of a user wearing the wearable device, wherein the image content is visible to the user when the eye is aligned with respect to the viewing zone. The panel illumination unit converges the light such that light emitted by the image panel converges into the viewing zone positioned based on the eye configuration information measured by the eye monitor.

FIG. 1 shows the principal optical elements of the HMD system. The device includes one or more light sources 1, a panel illumination unit 10, an image panel 3, and an eye monitor 11. The light source may include a plurality of independently switchable light source units that each emits light converging towards different points in space for generating multiple viewing zones at different directions. The light source in this embodiment is one or more independently switchable small white LEDs at different positions. However, the light source could also include one or more known light sources such as different color LEDs, laser diodes, lasers diode arrays, LED active/passive matrix arrays, or a scanning laser projector. A diverging beam 2 emitted from the light source is divergent and covers most or substantially all areas of the panel illumination unit. This can be achieved by using known optics, such as a condenser lens, to shape the divergence of the source. The source is incident onto the panel illumination unit 10 (also known as the backlight unit/backlight in the case where the image panel is transparent). The panel illumination unit has a structure that makes a converging light 8 converge towards the eye 4. The convergence angle 200 and the convergence point of this emerging beam determines the viewing zone size of the system.

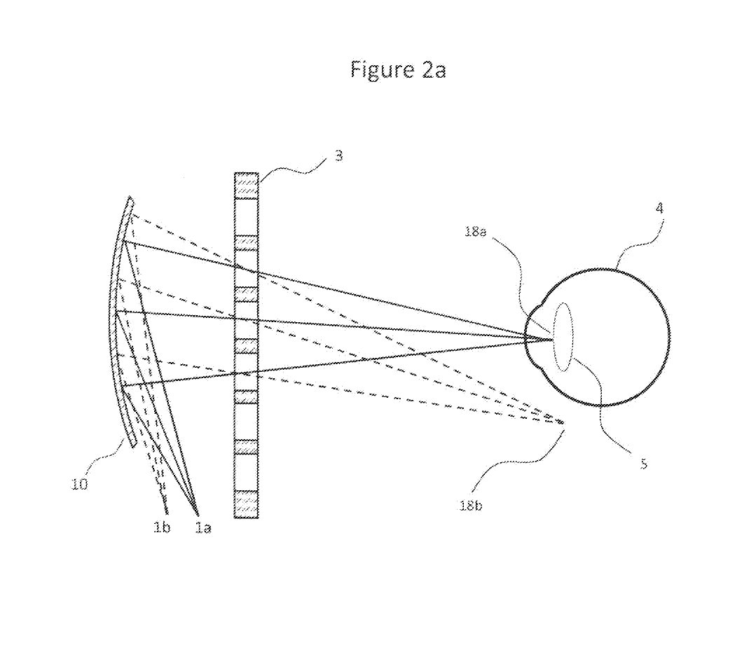

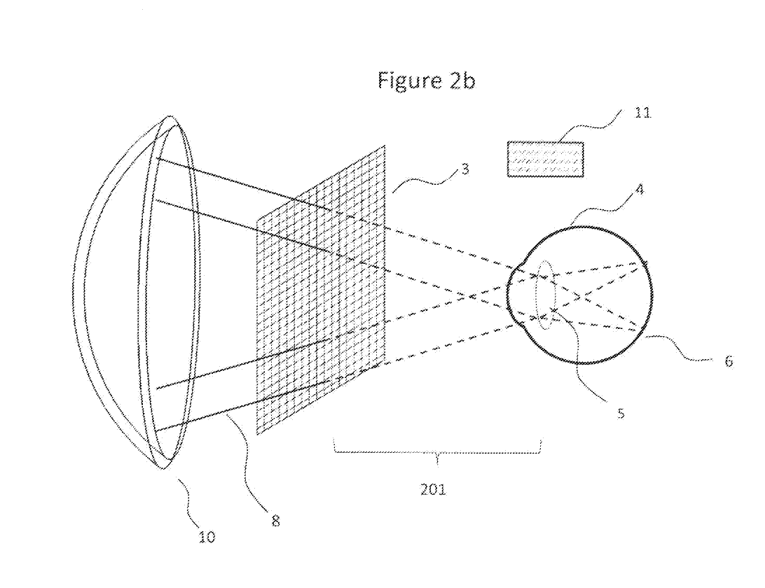

FIG. 2a shows that, with multiple small light source units (la-b) located at different positions, each independently switchable source would emit rays converging towards different points in space, creating different viewing zones 18a-b. The light source units are selectively switched on or off to generate the viewing zone based on eye configuration information measured by the eye monitor. Light only enters the eye if the pupil intercepts with one of these viewing zones. In exemplary embodiments, to correlate pupil position to the viewing zones, each viewing zone is smaller in at least one dimension than twice the measured pupil size. One light source may be switched on at any given time to create one viewing zone. However, one or more light sources can be switched on simultaneously to create multiple viewing zones.

The converging beam 8 illuminates an image panel 3 as shown in FIG. 2b. In a preferred embodiment, the image panel is a transparent pixelated liquid crystal display panel, similar to those used in conventional displays. However, the image panel could also include a layer of lenticular lenses, lens array, diffractive thin films, or other known LCD display panel structures which are known to help deflecting light in particular directions. The image panel could also be based on other known display panel technologies such as microelectromechanical system shutter arrays, or electrowetting panels.

The image panel is located at a distance 201 from the eye 4, and the image panel selectively transmits light at different pixels to generate the image content, with light emerging through each pixel being directed towards the eye 4. When only one small area light source is switched on, the light 8 incident onto the image panel 3 will be highly directional. Provided that the pixel size is not too small, light emerging through each pixel would substantially preserve the directionality of the incident light with only weak diffractive effects. The panel illumination unit is configured to limit divergence of light that is emitted from the image panel, such that when the display device is worn by the user, the image panel is located at a distance to the user's eye closer than a distance where the eye can effectively focus the pixels.

A diffraction effect of each pixel will lead to a weak divergence for light emerging from each pixel. Just before reaching the pupil 5 of the eye, the diverging beam from each pixel could have a diameter comparable to or smaller than the pupil. This divergence angle also needs to be small such that the eye's focusing mechanisms can accommodate for the beam to form a small pixel image on the retina 6. If the pixels in the image panel are too small, light emerging from a pixel will be diverging at a large angle due to diffraction, creating a large defocused pixel on the retina. On the other hand, if the pixels are too large, there would be too few pixels in the image panel within a given field of view (FoV) and given panel-to-eye distance. The effective resolution of the display could be maximized by optimizing the pixel size of the image panel such that both effects are balanced. The pixel apertures may also be circular or in other known shapes where the divergence angle of the diffracted beam is minimized.

The eye monitor 11 is a device used to monitor or measure information pertaining to an eye configuration of a user wearing the head mounted display device. In a preferred embodiment, the eye monitor includes a camera which is pointed at the eye, and a light source (which could be infrared such that it will be invisible for the user) for illuminating the eye. The camera may tracks the gaze direction, position, and pupil diameter of the eye to generate the eye configuration information. The system then switches on a light source according to the position of the eye to create a viewing zone that matches the pupil position based on the eye configuration information measured by the eye monitor, allowing light to be seen by the user. However, other technologies that gather information of the eye can also be used instead of the camera based eye tracker. One such example is a gaze tracker based on electrooculography. Information from the eye monitor can be used to control which light source (hence viewing zone) is to be switched on.

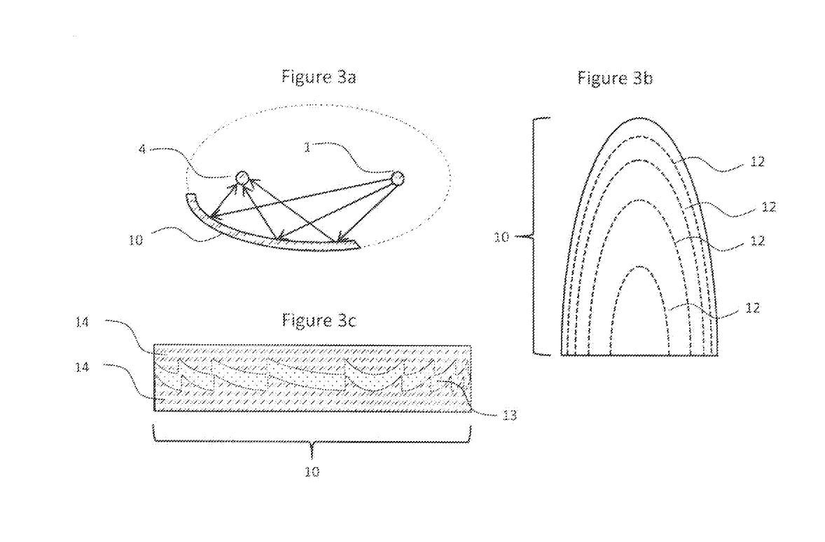

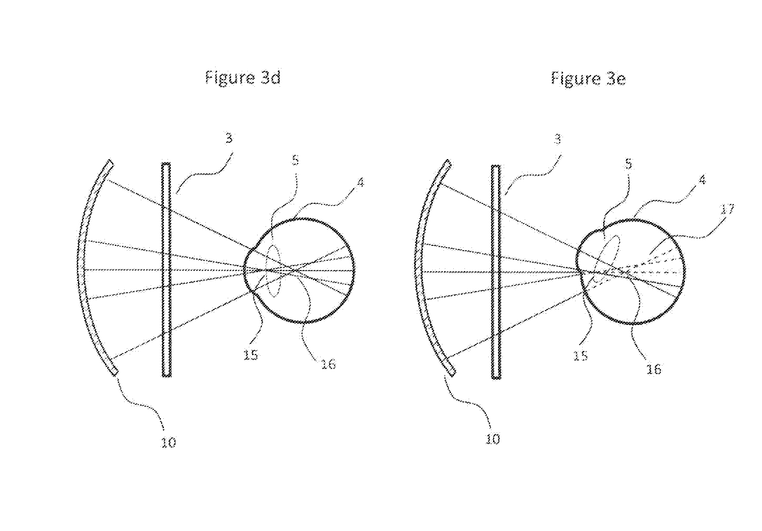

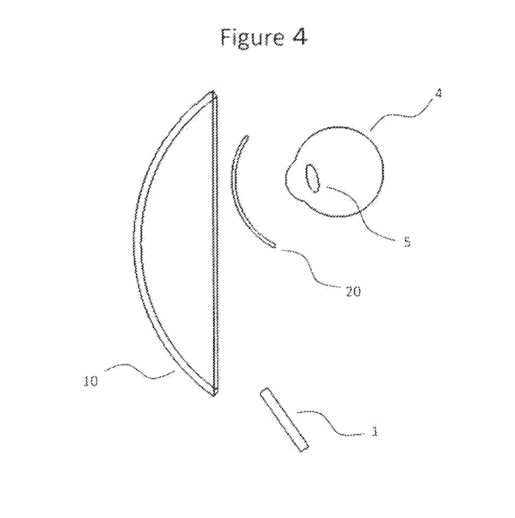

The panel illumination unit 10 in a preferred embodiment is configured as a curved mirror where one curved side is coated with a high reflectivity material. One possible shape of the mirror is shown in FIG. 3a. The mirror could be a free formed shape optimized from an ellipsoid. An ellipsoid includes two foci, allowing aberration free imaging from the light source 1 to the eye 4. The mirror could also be made into a Fresnel lens, as shown in FIG. 3b where the contours (prism peaks) 12 of the ellipsoid/free form curved surface are segmented and made into a thin compacted element. The element could also be embossed into a material as shown in FIG. 3c, where both sides of a transparent substrate 14 have matching refractive indices, and the curved element surface is coated with a thin and partially reflecting coating 13. In this case, ambient light transmitting (from the real world) through the element will not experience a refractive lens as the gap when the reflective material is thin, but light reflecting by the reflecting coating 13 will see an element with optical power as light is reflected by a curved surface.

Generally, the beam converging element could be a general free form element of any shape optimized for focusing one small area (the cluster of multiple light sources) to another (the eye). Due to the finite area of the pupil 4 and the segmentation of the mirror leading to offset in centers of curvature in each Fresnel zone, the optimal shape of the panel illumination unit 10 would not be an exact ellipsoid, but could be a shape perturbed from it. Such surface could be designed by numerical optimization in optical modelling software.

FIGS. 3d-e show that the convergence point for beams/rays may be at a higher or wider angle to converge at a different location or converging point 16 than beams/rays that are paraxial (at small angles) from the converging point paraxial from the optical axis 15. While the eye gazes directly forward (FIG. 3d), the pupil 5 will intercept all converging light. However, as the eye moves in order to view wider angle areas (FIG. 3e), the pupil 5 would shift with this eye motion. Having rays at wide angles converging further back at converging point 16 closer to the pivot at which the eye rotates would allow the pupil to intercept this beam directed near the fovea. Other rays 17 directed far away from the fovea are generally less important and would have less impact on the user's viewing experience if they are obstructed (dashed line) by the iris of the eye. This can be a point of calibration that can be incorporated into the creation of the holograms or by mechanical setting through the design of the panel illumination unit 10. This geometrical arrangement would allow the system to have decreased reliance on an accurate eye monitor 11. In some cases, if an HMD with a small field of view is sufficient, the eye monitor may not even be necessary.

Although the panel illumination unit is drawn to include a single reflective surface, such unit, without a loss of generality, can also be configured as a flat element utilizing a waveguide/light guide type backlight with the use of known extraction methods to produce a converging/directional/collimated beam. The flat element can be illuminated with a fixed laser or LED light source or projection system for time sequential operation. The backlight and SLM panels can form the basis of a flat modular arrangement, in which each component includes a layer of a stack. The advantage of this approach is that the display is then thin and lightweight and could be included into an eye unit no larger than a pair of spectacles.

Subsequent embodiments in this description will be made in reference to the first embodiment and only the differences between the subsequent embodiments and the first embodiments will be discussed.

### 2^{nd} Embodiment

The second embodiment is shown in FIG. 4, in which a curved image panel 20 is used. The image panel surface could be normal to the converging light. Since liquid crystal technologies often suffer from performance issues when light is incident at a large angle from the panel's surface normal, this configuration would offer advantages in providing better image quality compared to a flat panel.

### 3^{rd} Embodiment

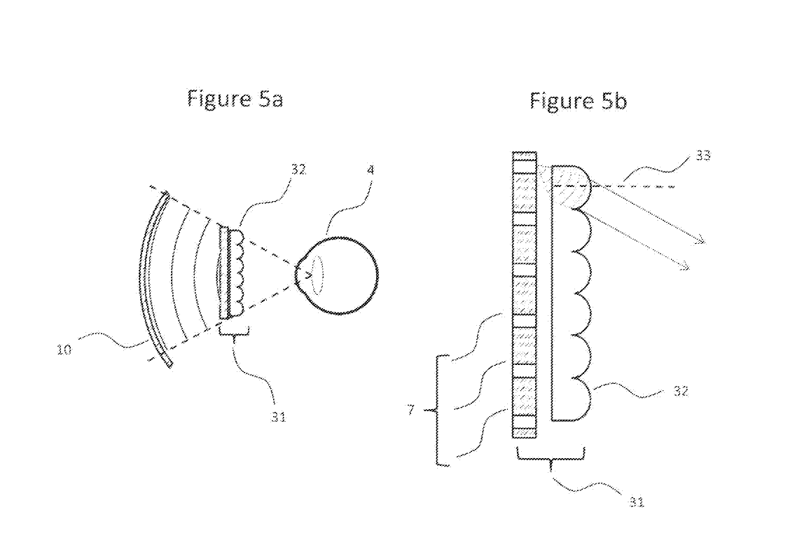

FIGS. 5a-5b show the third embodiment in which an image panel 31 includes a layer of lens array 32 including a plurality of lenslets located adjacent to the pixel panel, for improved collimation of light emerging from each pixel to limit divergence to further permit close positioning of the image panel relative to the eye. In this embodiment, the pixels 7 (FIG. 5b) in the image panel may have a fill ratio/aperture smaller than regular LCD panels such that light emerging from each pixel may have a high spatial coherence. A micro-lens with size larger than the pixel aperture is positioned closely after each pixel such that light can have an emerging beam with improved collimation. The ratio of the number of micro-lens lenslets to the number of pixels is could be 1:1 (each color pixel has its own private microlens), 1:3 (e.g. red, green, and blue pixel sharing one micro-lens), or other ratios not too large such that the display could remain a high effective resolution. As the beam is already converging, the micro lenses here can be used to correct for additional divergence or diffraction effects of the pixels. For example, since the pixels on a transparent image panel may never have a fill ratio reaching unity, the micro lens can serve to increase this fill ratio/aperture and decrease the divergence angle of the emerging beam. If the pixel apertures are not circular or are not in a shape which minimizes divergence angle of the diffracted beam, the lens array may also be used as a beam shaper to correct for the diffracted beam divergence.

The pitch of the lens array could, but not necessarily, have to exactly match the pixel pitch. For example, a device where the lens array's pitch matches a whole number multiple of the pixels' pitch could be easier to assemble; whereas a lens array 32 with a pitch slightly smaller than an integer multiple of the pixel's pitch (as drawn in FIG. 5b) could allow the optical axis of the micro-lens 33 to be offset slightly from the corresponding pixel, allowing more efficient coupling of light from the pixel aperture to the micro-lens. The pitch of the lens array 32 will be important for defining the convergence. In addition, the pitch may be non-linear to correct for non-linearity/non-paraxial in refraction and for different view point positions.

The lens array 32 in this embodiment is a refractive lens array where each micro-lens has a curved geometry. However, other known methods of lens array design, such as a holographic or diffractive lens array may also be used instead of this refractive lens array.

Poor efficiency arising from small pixel fill ratio could be improved with known methods such as using reflective pixel black masks.

In this embodiment, the panel illumination unit can also be planar as in the first embodiment (as a backlight for example, which includes a known type of collimated backlight interacting with other optical elements, for example an aperture & lens array to create a converging beam structure) which produces light converging towards the eye after the micro lens array by variation of the lens array's pitch.

### 4^{th} Embodiment

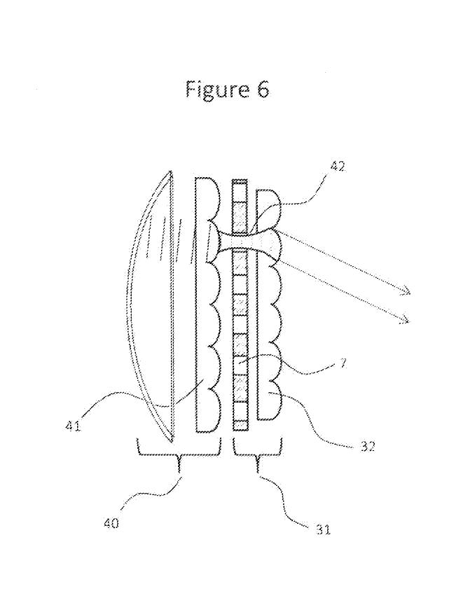

FIG. 6 shows the fourth embodiment according to a variation of the third embodiment, wherein the panel illumination unit 40 includes a second lens array 41 in addition to the original reflector described in the first embodiment which converges light towards the eye. This lens array is placed closely before or immediately adjacent the image panel between the reflector and the image panel. A micro-lens with size larger than the pixel aperture is positioned closely before each pixel such that the illumination by light beam 42 can be focused through each pixel aperture for improved efficiency.

The pitch of this second lens array 41 could, but not necessarily, have to match the pixel pitch. For example, a device where the lens array's pitch matches the pixels' pitch could be easier to be aligned; whereas a lens array 41 with a pitch slightly larger than the pixel's pitch could allow the optical axis of the micro-lens to be offset slightly from the corresponding pixel, allowing more efficient coupling of light from the panel illumination unit into each pixel. The pitch of this lens array can be non-linear and its alignment will be important for defining the convergence of light emerging through the pixel.

The second lens array 41 in this embodiment is a refractive lens array where each micro-lens has a curved geometry. However, other known methods of lens array design, such as a holographic or diffractive lens array may also be used instead of this refractive lens array.

In this embodiment, the panel illumination unit 40 can include a reflector or planar light guide that produces collimated/parallel light, but the lens array 41 has a pitch and alignment such that light emerging from this lens array through the pixel apertures are converging towards the eye.

### 5^{th} Embodiment

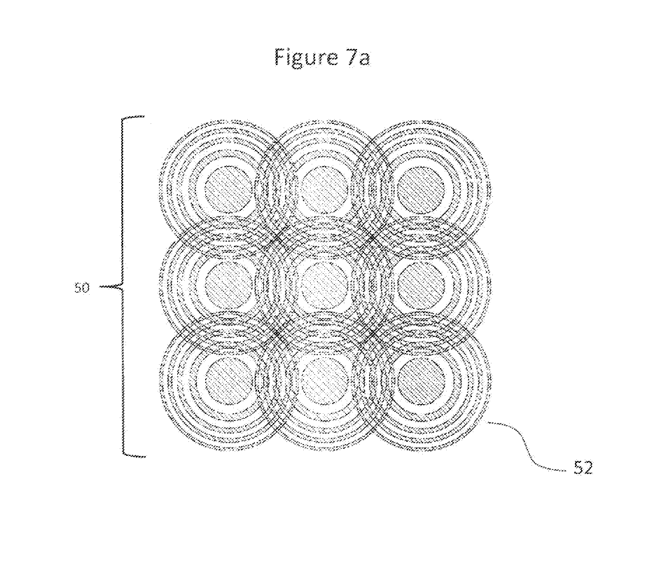

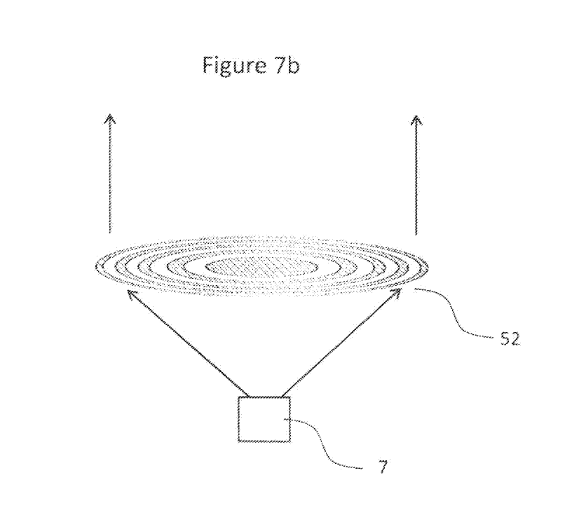

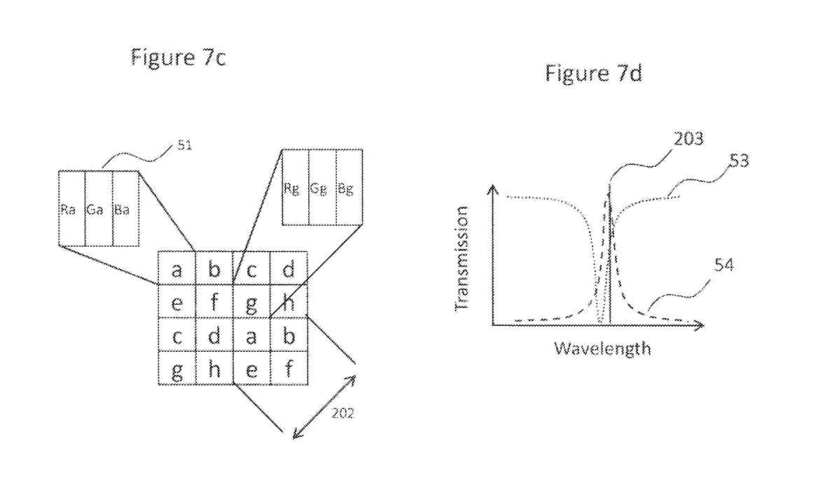

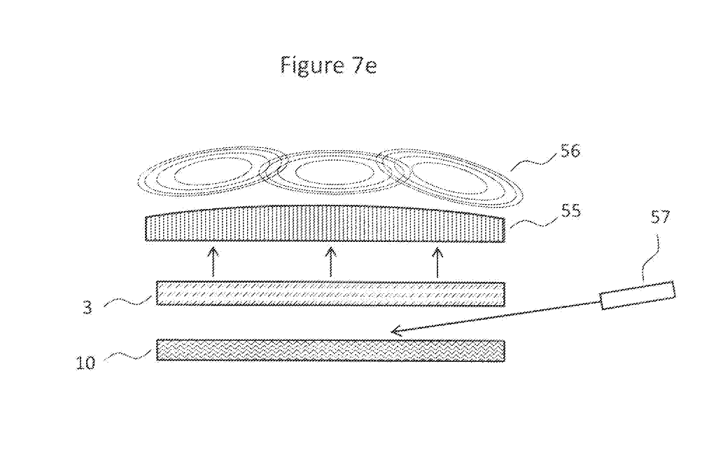

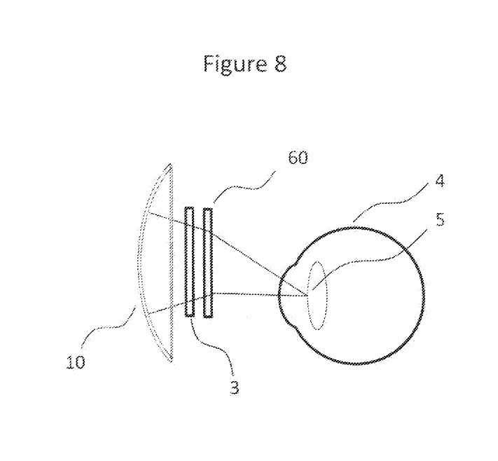

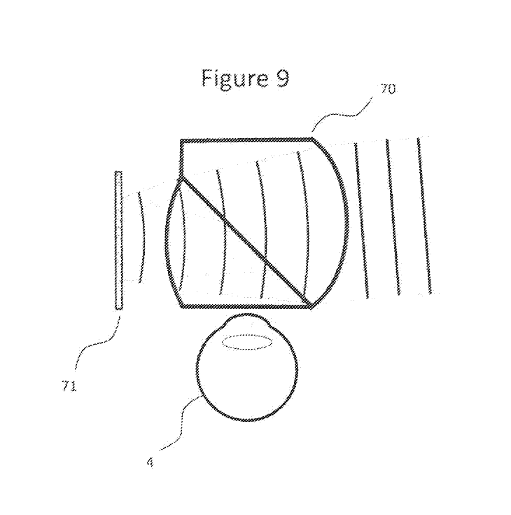

FIGS. 7a-e show a fifth embodiment that is a variation of the third embodiment, wherein the lens array is an overlapping holographic diffractive type lens array 50 (FIG. 7a). Each lenslet or micro-lens 52 of the lens array 50 has a size larger than the pixel pitch of the image panel such that the micro-lenses or lenslets have an effective aperture overlapping several adjacent micro-lenses. Each microlens would only focus light from a matching pixel. Such a lens array could be made from diffractive phase and/or amplitude elements, but may be also achievable with amplitude diffractive Fresnel zone plates.

As an example of achieving spatially overlapping zone plates, adjacent zone plates are made from a filter that absorbs/reflects different wavelengths. Instead of alternating between black and clear like common Fresnel zone plates, the zone plate of the micro-lens 52 (FIG. 7b) could alternate between two types of filter with different transmission spectra. The first type of filter may have a transmission spectrum transparent to the color transmitted from the matching pixel 7 underneath the zone plate. The second type of filter may have a transmission spectrum complementary to the color of this pixel (e.g. a zone plate designed to focus light emerging from a red pixel could alternate between transparent and cyan).

In this case, light of a different wavelength will not be modulated by the adjacent zone plates (e.g. light emitted from a green pixel will not be modulated by the zone plate designed for a red pixel that alternates between clear and cyan because both filters are transparent to green light). In addition, if the spectral width absorbed/reflected by a zone plate is narrow, it may be possible to have multiple filters for each color, each transmitting a slightly different spectrum, with colors indistinguishable to regular users. FIG. 7c shows an example of such scheme including an overlapping diffractive holographic lens 51 made of a plurality of different color filters. Each cell (a-h) contains a Fresnel zone plate that are visible to red, green, and blue wavelengths (R, G, B) of different spectrum X_{y} (where X [symbol] {R, G, B}, y [symbol] {a-h}). The reflected/absorbed spectra of adjacent Fresnel zone plates do not overlap. Fresnel zone plates transmitting the same spectra can be kept furthest apart at a closest distance 202 between micro-lenses transmitting the same wavelength. Such structure can be designed by the patterning multiple layers of interference filters.

FIG. 7d shows another method to produce a large number of spectrally separated, spatially overlapping micro-lenses by using a permutation of different pixel color filters 54, diffractive lens color filters 53, and/or emission wavelength 203 of a wavelength-tunable light source. If a tunable light source is used, the image panel could operate by sequentially switching on/off different subsets of pixels while the light source sweeps through varying wavelengths. Such light source could be a cavity tunable laser diode or multiple lasers of different wavelengths.

FIG. 7e shows yet another method of fabricating overlapping Fresnel zone plates each designed to be visible to different wavelengths. Here, a non-flat substrate 55 is used to deposit dielectric for thin film interference filters. Since the transmission spectrum of interference filters are known to be dependent on angle of incidence of light, each of Fresnel diffractive lens with zone plates 56 is made of interference filter on a non-flat substrate will each be visible to different wavelengths. A tunable laser 57 can then be used as the tunable light source to illuminate the system. While the wavelength of the tunable laser is rapidly varied, the image panel may display subsets of pixels sequentially within an image frame.

Another exemplary method to avoid cross talk in an overlapping diffractive lens could also involve exploiting the incident angle dependent properties of the interference filter. In this method, the diffractive lenses are also made from a patterned interference filter. However in this configuration, the diffractive lens is designed in a way such that a wrong pixel transmitting the same wavelength as the matching pixel could not contribute to crosstalk due to the large blue shift of the interference filter from the perspective of the wrong pixel.

Yet another method to achieve Fresnel zone plates responsive to a large number of different spectra would involve the use of grayscale lithography fabrication methods to produce Nano-structures of different thicknesses or photonics crystal with different periodicity. Such structures may be fabricated with reasonable production time with grayscale lithography.

### 6^{th} Embodiment

FIG. 8 shows a sixth embodiment wherein a spatial light modulator (SLM) 60 is added to the HMD to steer the position of the viewing zone. In particular, the SLM is configured to steer light emitted from the image panel into the viewing zone based on the eye configuration information measured by the eye monitor. The SLM in this embodiment is a liquid crystal panel, but can also use other technologies which add a spatially varying phase and/or amplitude modulation to a light beam, such as liquid crystal on silicon (LCoS), electro-wetting panels, and pixelated MEMS mirror arrays.

The SLM is capable of steering a light beam based on information obtained from the eye monitor. For example, if the eye monitor detects a change in gaze direction of the eye, the SLM can change the position of the converging point (viewing zone) of the HMD accordingly such that the image remains visible to the user. Depending on the exact beam steering angle requirements and panel size requirements, the SLM can also be placed in other locations to achieve the same purpose. For example, the SLM can be placed between the image panel 3 and panel illumination unit 10, or between the light source 1 and the panel illumination unit 10.

### 7^{th} Embodiment

FIG. 9 shows a seventh embodiment wherein, instead of using a transparent image panel, a reflective image panel 71 is used. The image panel may be a liquid crystal on silicon (LCoS) panel, but may also be other reflective image panels such as digital micro-mirror device (DMD). The panel illumination unit 70 may include refractive lens(es) combined with a (polarizing/non-polarizing) beam splitter. The refractive lens(es) creates an illumination optically converging towards the eye similar to the first embodiment. The beam splitter separates the light paths before and after the image panel by reflecting one path and transmitting the other. Despite the use of refractive lens(es) and beam splitter in this embodiment, the curved panel illumination unit described in the primary embodiment can also be used if the optical axis before and after the image panel are not parallel and not orthogonal to each other. In this case, the beam splitter may not be necessary either. Although reflective image panels may lead to an HMD design with fold-up optics, the unfolded geometrical optics configuration of the system would be the same as using a transparent image panel.

An aspect of the invention is a head mounted display device. In exemplary embodiments, the head mounted display device includes a switchable light source that is switched to emit light for generating at least one viewing zone, a panel illumination unit that is illuminated by the light source, and an image panel. The panel illumination unit converges the light onto the image panel and the image panel selectively transmits light at different pixels to generate image content, wherein the image content is visible to the user when the eye is aligned with respect to the viewing zone. The panel illumination unit converges the light such that light emitted by the image panel converges into the viewing zone at a direction based on the eye configuration. The head mounted display device may include one or more of the following features, either individually or in combination.

In an exemplary embodiment of the head mounted display device, the panel illumination unit is configured to limit divergence of light that is emitted from the image panel, wherein when the display device is worn by the user, the image panel is located at a distance from the user's eye closer than a distance where the eye can focus the pixels.

In an exemplary embodiment of the head mounted display device, the switchable light source comprises a plurality of independently switchable light source units that each emits light converging towards different points in space for generating multiple viewing zones at different directions, and the light source units are selectively switched on or off to generate the viewing zone based on the eye configuration information measured by the eye monitor.

In an exemplary embodiment of the head mounted display device, the image panel is a transparent pixellated liquid crystal display panel.

In an exemplary embodiment of the head mounted display device, the device further includes an eye monitor that measures eye configuration information, wherein the panel illumination unit converges the light such that light emitted by the image panel converges into the viewing zone at a direction based on the eye configuration information measured by the eye monitor. The eye monitor may be configured to measure pupil size of the user, and the image panel is configured to minimize divergence of light such that the viewing zone is smaller in at least one dimension than twice the measured pupil size.

In an exemplary embodiment of the head mounted display device, the eye monitor comprises a gaze tracker that is configured to measure gaze direction, pupil position, and pupil diameter as included in the eye configuration information.

In an exemplary embodiment of the head mounted display device, the panel illumination unit comprises a curved mirror with a reflective coating on one curved side.

In an exemplary embodiment of the head mounted display device, the panel illumination unit is configured as a Fresnel lens.

In an exemplary embodiment of the head mounted display device, the panel illumination unit comprises a transparent substrate and a curved element with a reflective coating.

In an exemplary embodiment of the head mounted display device, the image panel is curved.

In an exemplary embodiment of the head mounted display device, the image panel comprises a lens array including a plurality of lenslets located adjacent a pixel panel, wherein the lenslets collimate light emerging from the pixels.

In an exemplary embodiment of the head mounted display device, a pitch of the lenslets matches a pixel pitch such that the lenslets selectively collimate light emerging from respective pixels.

In an exemplary embodiment of the head mounted display device, the lens array comprises overlapping holographic diffractive lenslets.

In an exemplary embodiment of the head mounted display device, the overlapping holographic diffractive lenslets comprise a plurality of different color filters.

In an exemplary embodiment of the head mounted display device, the overlapping holographic diffractive lenslets are formed on spatially overlapping zone plates.

In an exemplary embodiment of the head mounted display device, the zone plates are deposited on a non-flat dielectric substrate.

In an exemplary embodiment of the head mounted display device, the pixel illumination unit comprises a reflector and a lens array located immediately adjacent to the image panel and between the reflector and the image panel.

In an exemplary embodiment of the head mounted display device, the device further includes a spatial light modulator (SLM) configured to steer light emitted from the image panel into the viewing zone based on the eye configuration information measured by the eye monitor.

In an exemplary embodiment of the head mounted display device, the SLM is one of a liquid crystal panel, liquid crystal on silicon panel, electro-wetting panel, or pixellated micro-electro-mechanical systems (MEMS) mirror array.

In an exemplary embodiment of the head mounted display device, the image panel is a reflective image panel.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous

### INDUSTRIAL APPLICABILITY

Industrial application will be mainly for wearable displays, in particular for achieving light weight Head Mounted Displays (HMD). The principal advantage of the invention allows HMD to be designed light weight as no large eyepiece lenses are required. Hardware manufactured using this invention may be useful in the fields of virtual reality (VR) and augmented reality (AR) for both consumer and professional markets. HMD manufactured by this invention could have applications including everyday use, gaming, entertainment, task support, medical, industrial design, navigation, transport, translation, education, and training.

1. A head mounted display device comprising:
a switchable light source that is switched to emit light for generating at least one viewing zone;
a panel illumination unit that is illuminated by the light source; and
an image panel, wherein the panel illumination unit converges the light onto the image panel and the image panel selectively transmits light at different pixels to generate image content;
wherein the image content is visible to the user when the eye is aligned with respect to the viewing zone; and
wherein the panel illumination unit converges the light such that light emitted by the image panel converges into the viewing zone at a direction based on eye configuration.

2. The head mounted display device of claim 1, wherein the panel illumination unit is configured to limit divergence of light that is emitted from the image panel, wherein when the display device is worn by the user, the image panel is located at a distance from the user's eye closer than a distance where the eye can focus the pixels.

3. The head mounted display device of claim 1, wherein the switchable light source comprises a plurality of independently switchable light source units that each emits light converging towards different points in space for generating multiple viewing zones at different directions, and the light source units are selectively switched on or off to generate the viewing zone based on the eye configuration information measured by the eye monitor.

4. The head mounted display device of claim 1, wherein the image panel is a transparent pixellated liquid crystal display panel.

5. The head mounted display device of claim 1, wherein the eye monitor is configured to measure pupil size of the user, and the image panel is configured to minimize divergence of light such that the viewing zone is smaller in at least one dimension than twice the measured pupil size.

6. The head mounted display device of claim 1, further comprising an eye monitor that measures eye configuration information, wherein the panel illumination unit converges the light such that light emitted by the image panel converges into the viewing zone at a direction based on the eye configuration information measured by the eye monitor; and
the eye monitor comprises a gaze tracker that is configured to measure gaze direction, pupil position, and pupil diameter as included in the eye configuration information.

7. The head mounted display device of claim 1, wherein the panel illumination unit comprises a curved mirror with a reflective coating on one curved side.

8. The head mounted display device of claim 1, wherein the panel illumination unit is configured as a Fresnel lens.

9. The head mounted display device of claim 1, wherein the panel illumination unit comprises a transparent substrate and a curved element with a reflective coating.

10. The head mounted display device of claim 1, wherein the image panel is curved.

11. The head mounted display device of claim 1, wherein the image panel comprises a lens array including a plurality of lenslets located adjacent a pixel panel, wherein the lenslets collimate light emerging from the pixels.

12. The head mounted display device of claim 11, wherein a pitch of the lenslets matches a pixel pitch such that the lenslets selectively collimate light emerging from respective pixels.

13. The head mounted display device of claim 11, wherein the lens array comprises overlapping holographic diffractive lenslets.

14. The head mounted display device of claim 13, wherein the overlapping holographic diffractive lenslets comprise a plurality of different color filters.

15. The head mounted display device of claim 13, wherein the overlapping holographic diffractive lenslets are formed on spatially overlapping zone plates.

16. The head mounted display device of claim 15, wherein the zone plates are deposited on a non-flat dielectric substrate.

17. The head mounted display device of claim 1, wherein the pixel illumination unit comprises a reflector and a lens array located immediately adjacent to the image panel and between the reflector and the image panel.

18. The head mounted display device of claim 1, further comprising a spatial light modulator (SLM) configured to steer light emitted from the image panel into the viewing zone based on the eye configuration information measured by the eye monitor.

19. The head mounted display device of claim 18, wherein the SLM is one of a liquid crystal panel, liquid crystal on silicon panel, electro-wetting panel, or pixellated micro-electro-mechanical systems (MEMS) mirror array.

20. The head mounted display device of claim 1, wherein the image panel is a reflective image panel.
